(19) United States
(12) Patent Application Publication
(10) Pub. No.: US 2013/0338307 A1
(43) Pub. Date: Dec. 19, 2013

(54) NATURAL OIL BASED POLY-URETHANE DISPERSION

(71) Applicants: Puja Jain, Gurgaon (IN); Sandeep Jain, Gurgaon (IN)

(72) Inventors: Puja Jain, Gurgaon (IN); Sandeep Jain, Gurgaon (IN)

(73) Assignee: ROIDEC INDIA CHEMICAL (P) LTD, Karol Bagh, New Delhi, IN (IN)

(21) Appl. No.: 14/001,205

(22) PCT Filed: Apr. 27, 2011
(86) PCT No.: PCT/IN11/00286

§ 371 Date: Aug. 23, 2013

(30) Foreign Application Priority Data
Mar. 1, 2011 (IN) 553/DEL2011

(51) Int. Cl. C09J 175/04; C08L 75/04

(52) U.S. Cl. CPC C09J 175/04; C08L 75/04
USPC 524/591

(57) ABSTRACT

This invention relates to a natural oil based poly-urethane dispersion of water-based anionic polyurethane/urea polymer of high molecular weight by forming a water dispersible NCO-terminated polyurethane pre-polymer, consisting essentially of the reaction product of a polyol component and a polyisocyanate component, at a reduced temperature, which is then dispersed in solvent-free water after applying a neutralizing agent, and then reacted with a chain extender. The polyol component used in this invention comprises of a mixture of (a) ricinoleated natural ester based mono blocked polyol; and (c) carboxylic group-containing polyols. The polyisocyanate component used is an aromatic diisocyanate such as an isomer of toluene diicocyanate and/or methylene diphenyl diisocyanate. The dispersion produced as a result of the process described herein is biodegradable in nature and non-plastic. The dispersion is also free of volatile organic chemicals and/or leachable contaminants. On account of the superior characteristics of the dispersion produced in this invention, it can be widely applied in industry for, among others, direct food contact applications.

### FIELD OF THE INVENTION

This invention relates to a natural oil based poly-urethane dispersion of water-based anionic polyurethane/urea polymer of high molecular weight, which is substantially free of volatile organic chemicals and/or leachable contaminants, and is non plastic and biodegradable in nature. On account of the superior properties/characteristics of this natural oil based poly-urethane dispersion, the same is capable of wide industrial application.

### BACKGROUND OF THE INVENTION

It is generally known that water-based anionic polyurethane-urea polymers are useful. References describing such include the following:
1. E.P. Patent No. 647665 discloses a dispersion for use as a coating on hard surfaces. In this patent, the dispersion is based on alcoholised drying oils. Further, the dispersion disclosed in this patent preferably uses an aliphatic or cyclic polyisocynate. However, this dispersion is not suitable for direct food contact applications since it is neither free of volatile and/or leachable contaminants, nor is it biodegradable and non-plastic. The composition of the dispersion disclosed in E.P. Patent No. 647665 does not make it suitable in industry either.
2. U.S. Pat. No. 5,834,554 discloses a dispersion based on a sulfonated polyester based polyol, which is commonly known in prior art. However, the dispersion disclosed in U.S. Pat. No. 5,834,554 does not possess the features of being non-plastic and bio-degradable in nature. The dispersion of U.S. Pat. No. 5,834,554 is not based on an alternative polyol based on renewable feed stocks as is disclosed herein. It also does not disclose using a neutralising agent to produce the dispersion as is disclosed herein. This patent also does not use a chain extension mechanism as has been disclosed herein.
3. Similar drawbacks, as discussed with respect to U.S. Pat. No. 5,834,554, are also associated with U.S. Pat. No. 5,637,639.
4. The dispersion produced in U.S. Pat. No. 6,017,998 does not employ, amongst others, an alternative polyol based on renewable feed stocks as is disclosed herein. The dispersion so produced also lacks the characteristics of being non-plastic and bio-degradable in nature. Additionally, the dispersion disclosed in U.S. Pat. No. 6,017,998 cannot be used in direct food contact applications.
5. U.S. Pat. No. 5,037,864 discloses a semi-continuous process for preparation of a dispersion using certain containers. In this prior art, however, use of an alternative polyol based on renewable feed stocks is not disclosed. The dispersion produced in this prior art is neither free of volatile and/or leachable contaminants, nor is it biodegradable and non-plastic. The dispersion produced here is inapplicable for direct food contact applications.
6. U.S. Pat. No. 7,193,011 discloses a process of preparing a dispersion, similar to U.S. Pat. No. 5,037,864, and suffers from similar drawbacks.
7. U.S. Pat. No. 6,084,051, U.S. Pat. No. 6,642,304 and U.S. Pat. No. 6,515,070 also disclose a process of preparing a dispersion, which suffers from various drawbacks discussed above. These prior arts use reactants and reacting conditions, which make the dispersion unfit for use for direct food contact applications.
8. UK Pat. No. 1,128,568 (Farbenfabriken Bayer Aktiengesellschaft) discloses a laminating adhesive wherein anionic polyesteramide polyols are used in the preparation of water-based sulfonated/carboxylated polyurethane-urea polymers. The NCO-terminated prepolymers are processed with acetone.
9. U.S. Pat. No. 5,334,690 (Hoechst Aktiengesellschaft, Fed.) discloses a water-based sulfonated/carboxylated polyurethane-urea adhesive, wherein the anionic groups are present in the polyol segment. The solvent-less prepolymers are processed at temperatures greater than 120° C. C.
10. U.S. Pat. No. 4,851,459 and U.S. Pat. No. 4,883,694 (Century Adhesives Corp) disclose high performance water dispersible polyurethane laminating adhesives: wherein the NCO-terminated prepolymers are dispersed in water and chain extended with peroxides containing hydrogen active atoms. In the preferred method of the invention, a tertiary amine is added to neutralize the anionic prepolymer.

The prior art teachings disclose water-based anionic polyurethane-urea laminating adhesives processed with volatile and/or leachable contaminants. Contaminants such as cosolvents, urethane catalysts and organic chain terminators can be detrimental.

There is also no prior art, which discloses a dispersion that has characteristics of being non-plastic and bio-degradable in nature.

None of the prior art teachings prefer the use of aromatic polyisocyanates in making the dispersion.

Another disadvantage associated with the prior art teachings relates to processing temperatures and polymer composition. Elevated temperatures can increase the prepolymer's crosslink density through uncontrolled isocyanate side reactions. For example, as described in the “Encyclopedia of Polymer Science and Engineering,” Vol. 13, page 252, isocyanates react with the NH group of urethanes, ureas and amides at 100° C. to 140° C. to form allophanates, biurets and acyl ureas, respectively. Polymer composition can also increase the adhesive's heat activation temperature.

To meet governmental standards, there remains a long-standing need for producing a dispersion, which is substantially non-plastic, biodegradable, free of volatile and/or leachable contaminants, and can be produced at reduced heat activation temperatures. The use of alcoholised drying oil has been unable to, solve this problem in prior art.

There is no single solution to all the problems associated with prior art, and which can be effectively applied in industry, keeping in mind the stringent standards laid down by the government for direct food contact applications.

### AIMS AND OBJECTIVES OF THE INVENTION

The fundamental objective of this invention is to disclose a natural oil based poly-urethane dispersion of water-based anionic polyurethane/urea polymer of high molecular weight by forming a water dispersible NCO-terminated polyurethane pre-polymer consisting essentially of the reaction product of a polyol component, comprising primarily of ricinoleated natural ester based mono blocked polyol (which is prepared without using the system of alcoholysis for deriving the blocked natural ester oil) and an aromatic polyisocyanate component, at a reduced temperature, which is then neutralised and dispersed in solvent-free water and reacted with a chain extender.

Yet another objective of this invention is to disclose a natural oil based poly-urethane dispersion, which is produced at reduced temperatures.

Another objective of this invention is to disclose a natural oil based poly-urethane dispersion, which is substantially free of volatile organic chemicals and/or leachable contaminants.

Another objective of this invention is to disclose a natural oil based poly-urethane dispersion, which is non plastic in nature.

Yet another objective of this invention is to disclose a natural oil based poly-urethane dispersion, which is biodegradable in nature.

Consequently, another objective of this invention is to disclose a natural oil based poly-urethane dispersion, which can be widely used in industry due to its superior qualities/characteristics.

Another objective of this invention is to disclose a natural oil based poly-urethane dispersion, which is efficient and economical to produce.

Another objective of this invention is to disclose a natural oil based poly-urethane dispersion, which can be used to produce a packaging material, which can be widely applied in industry.

Specifically, the objective of this invention is to disclose a natural oil based poly-urethane dispersion, which can be used as a laminating adhesive.

Also, the objective of this invention is to disclose a natural oil based poly-urethane dispersion, which can be used on conventional lamination machines for preparing flexible film or other packaging laminates.

Additionally, the objective of this invention is to disclose a natural oil based poly-urethane dispersion, which can be used to produce a packaging material, which would possess properties of being waterproof, durable, long lasting, environment friendly, user friendly and capable of sealing heat.

Specifically, the objective of this invention is to disclose a natural oil based poly-urethane dispersion, which can be used to produce a packaging material suitable for, amongst others, direct food contact and durable-goods applications.

Additional objects and advantages of the invention will become apparent to those skilled in the art.

### DESCRIPTION OF THE INVENTION

This invention provides a natural oil based poly-urethane dispersion, produced by a polymer-polyol blend, which includes a mixture of ricinoleated natural ester based mono blocked polyol and a carboxylic group-containing polyols.

Ricinoleated natural ester based mono blocked polyol is prepared by way of a multi-step process, without using the system of alcoholysis for deriving the blocked natural ester oil. Examples of natural oils used include plant-based oils (e.g., vegetable oils) and animal fats. Useful natural oil sources include canola oil, tall oil, soybean oil, safflower oil, linseed oil, castor oil, corn oil, sunflower oil, olive oil, canola oil, sesame oil, cottonseed oil, palm-based oils, rapeseed oil, tung oil, peanut oil, jatropha oil, and combinations thereof. Animal fats may also be used, for example, fish oil, lard, and tallow. The plant-based oils may be natural or genetically modified vegetable oils, for example, high oleic safflower oil, high oleic soybean oil, high oleic canola oil, high oleic peanut oil, high oleic sunflower oil, and high erucic rapeseed oil (crambe oil). Also included are microbial oils, such as algal oil, including those that are genetically modified to increase yields and/or to obtain selective fatty acid distributions.

In the preferred embodiment of the invention, the ricinoleated natural ester based mono blocked polyol, disclosed herein, constitutes up to about 95% by weight of the total weight of the polyol formulation.

The carboxylic group-containing polyols used in accordance with this invention are advantageously dihydroxy materials. The carboxylic group-containing polyol can be reacted, without any significant reaction between the carboxylic groups and the diisocyanate component. Among the polyols which may be employed are those which have relatively unreactive free carboxylic acid groups, for instance, the alkanoic acids having one or two substituents on the alpha carbon atom. The substituent may be, for example, a hydroxyl or alkyl group, for example, an alkylol group. This component of the polyol composition has at least one carboxylic group, and generally has 1 to about 3 carboxylic groups, per molecule. The polyols which may conveniently be employed in accordance with this invention frequently have about 2 to 20, or more, preferably about 2 to 10, carbon atoms such as tartaric acid, the α,α-dialkylol alkanoic acids, e.g., having alkylol groups of about 1 to 3 carbon atoms, and the like. A preferred group are the α,α-dimethylol alkanoic acids. The α,α-dimethylol alkanoic acids which may be employed in accordance with this invention include 2,2-dimethylol acetic acid, 2,2-dimethylol propionic acid, 2,2-dimethylol butyric acid, 2,2-dimethylol pentanoic acid, and the like. The carboxylic group-containing polyol may frequently provide about 5% to 50% by weight of the total polyol component in the prepolymer.

The polyisocyante component used in the preparation of the water dispersible NCO-terminated polyurethane prepolymer is an isomer of toluene diisocyanate and methylene diphenyl diisocyanate. The ratio of the polyisocyanate component to the polyol component can be 1:4, and is most preferably 1:2.

To reduce the risk of worker exposure to inhalation, it is important not to exceed a temperature of 100° C. during the prepolymer synthesis reaction.

The NCO-terminated prepolymer is prepared by reacting a stoichiometric excess of the said polyisocyante component with the said polyol component. The materials are processed at temperatures ranging from about 10° C. to about 100° C., and preferably from about 40° C. to about 100° C. The reactants are in such proportions that the resulting percent isocyanate is in a range from about 20% to 40% by weight of the total prepolymer solids.

Although, the presence of a solvent for the prepolymer or the polyurethane-urea is not necessary to provide a stable dispersion, the prepolymer may be optionally prepared in the presence of solvent, provided that the solvent is substantially non-reactive in the context of the isocyanate-polyol reaction. The solvents are preferably organic and may be comprised essentially of carbon and hydrogen with or without other elements such as oxygen or nitrogen. Solvents which may be employed include dimethylformamide, esters, ethers, ketoesters, ketones, e.g., methyl ethyl ketone and acetone, glycolether-esters, chlorinated hydrocarbons, aliphatic and alicyclic hydrocarbon-substituted pyrrolidinones, e.g., N-methyl-2-pyrrolidinone, hydrogenated furans, aromatic hydrocarbons, and the like, and mixtures thereof.

The amount of solvent employed should be sufficient to provide a prepolymer solution, which has a sufficiently low viscosity to enhance the formation of the polyurethane-urea dispersion of this invention. However, the solutions may be successfully employed in forming the dispersion of this invention, even though the viscosity of the solution is relatively high at the temperature of dispersion. Often about 0.01 to 10 parts by weight of solvent per part by weight of the prepolymer can be used.

Often, when solvent is employed during the preparation of the isocyanate-terminated prepolymer and/or the polyurethane-urea, it is desirable to remove atleast a portion of the solvent from the dispersion. Advantageously, the solvent, which is to be removed from the dispersion, has a lower boiling point than water. Thus the solvent can be removed from the dispersion by, for example, distillation. The removal of the low boiling solvent is desirably conducted under conditions which are not deleterious to the polyurethane-urea such as by vacuum distillation or thin film evaporation. A solvent, having a higher boiling point than water, such as dimethyl formamide, N-methyl-2-pyrrolidinone, and the like, may be employed. In such a case, the higher boiling solvent is generally retained in the polyurethane-urea dispersion polymer to enhance the coalescence of the polyurethane-urea particles.

In order to render the prepolymer ‘water-dispersible’, the potential anionic groups must be neutralized before, during, or after their incorporation into the polyurethane-ureas, with the help of suitable neutralizing agents or mixtures thereof. Suitable compounds for neutralizing the potential anionic groups are the primary, secondary, or tertiary amines. Of these the trialkyl-substituted tertiary amines are preferred. Examples of these amines are trimethyl amine, triethyl amine, triisopropyl amine, tributyl amine, N,N-dimethyl-cyclohexyl amine, N,N-dimethylstearyl amine, N,N-dimethylaniline, N-methylmorpholine, N-ethylmorpholine, N-methylpiperazine, N-methylpyrrolidine, N-methylpiperidine, N,N-dimethyl-ethanol amine, N,N-diethyl-ethanol amine, triethanol amine, N-methyl-diethanol amine, dimethylaminopropanol, 2-methoxyethyldimethyl amine, N-hydroxyethylpiperazine, 2-(2-dimethylaminoethoxy)-ethanol and 5-diethylamino-2-pentanone. The most preferred tertiary amines are those which do not contain active hydrogen(s) as determined by the Zerewitinoff test since they are capable of reacting with the isocyanate groups of the prepolymers which can cause gelation, the formation of insoluble particles or chain termination.

The tertiary amines are especially advantageous since the salts formed from these amines are capable of decomposing under ambient conditions with volatilization of the tertiary amine. Another advantage of these tertiary amines is that they do not take part in the isocyanate-polyol reaction. For example, when isocyanate-terminated prepolymers containing potential anionic groups are formed, it would be difficult to neutralize these groups prior to dispersion in water with primary or secondary amines due to the fact that these amines may react with the free isocyanate groups of the prepolymer. In this context, these primary or secondary amines act more like chain terminators or chain extenders than neutralizing agents, and make the subsequent high molecular weight build-up during the aqueous chain extension step more difficult and less predictable. Thus, if primary and secondary amines are used, they should preferably be used only as neutralizing agents prior to the formation of the prepolymer, i.e., when the potential anionic groups are converted to anionic groups prior to their incorporation into the prepolymer. However, the tertiary amines are preferred even when neutralization is conducted in this manner.

When the potential anionic groups of the prepolymer are neutralized, they provide hydrophilicity to the prepolymer and better enable it to be stably dispersed in water. The potential, or unneutralized, anionic groups do not provide this degree of hydrophilicity. Accordingly, a sufficient amount of the potential ionic groups must be neutralized so that when combined with the optional hydrophilic ethylene oxide units, the polyurethane-urea final product will be a stable dispersion.

Generally, at least about 75%, preferably atleast about 90%, of the potential anionic groups are neutralized to the corresponding anionic groups. Larger amounts of potential ionic groups may remain unneutralized. However, there are no advantages to be gained from large quantities of unneutralized potential anionic groups and their presence could be detrimental as they would minimize the improvements in hydrolytic stability, which is obtained in accordance with this invention. When smaller amounts of potential ionic groups are incorporated, it may be necessary to neutralize substantially all of these groups to obtain the desired amount of hydrophilicity.

No firm guidelines can be given as to the amount of anionic groups needed, since the dispersibility of the polyurethane-urea depends on many factors including, but not limited to, the amount of hydrophilicity required, the desired particle size and the application requirements.

The neutralization steps may be conducted:
1. prior to prepolymer formation by treating the component containing the potential ionic groups(s);
2. after prepolymer formation, but prior to dispersing the prepolymer; or
3. by adding the neutralizing agent to all or a portion of the dispersing water. The reaction between the neutralizing agent and the potential anionic groups may be conducted at temperatures below about 90° C., preferably between about 30° and 80° C., with agitation of the reaction mixture.

Once the NCO-terminated prepolymer has been formed, it is dispersed in distilled/de-ionized water with mild agitation. The water temperature before dispersing is in a range from about 5° C. to about 90° C., and preferably from about 25° C. to about 85° C.

The dispersed NCO-terminated prepolymer is then chain extended with a polyamine. The polyamine component is a polyamine or a mixture of polyamines having an (average) amine functionality of 2 to 3 and an (average) molecular weight of from 50 to about 2000, preferably 50 to about 300. The presence of primary and/or secondary amino groups in the polyamines mentioned is crucial.

Suitable polyamines include ethylenediamine, 1,2- and 1,3-diaminopropane, 1,4-diaminobutane, 1,6-diaminohexane, isophoronediamine, isomer mixture of 2,2,4-and 2,4,4-trimethylhexa-methylenediamine, 2-methyl-pentamethylenediamine, diethylene-triamine, 1,3- and 1,4-xylylenediamine, α,α,α′, α′-tetramethyl-1,3- and -1,4-xylylenediamine and 4,4-diaminodicyclohexylmethane. Suitable diamines in the context of the invention are also hydrazine, hydrazine hydrate and substituted hydrazines, such as, for example, N-methylhydrazine, N,N′-dimethylhydrazine and their homologues and acid dihydrazides, adipic acid, β-methyladipic acid, sebacic acid, hydracrylic acid and terephthalic acid, semicarbazicloalkylene hydrazides, such as, for example, β-semicarbazidopropionic acid hydrazide (e.g. DE-A 17 70 591), semicarbazidoalkylene-carbazine esters, such as, for example, 2-semicarbazidoethylcarbazine ester (e.g. DE-A 19 18 504), or aminosemicarbazide compounds, such as, for example, 13-aminoethyl semicarbazido-carbonate (e.g. DE-A 19 02 931).

In addition to these low molecular weight polyamines having a molecular weight of up to 300, it is also possible, in principle, to use polyamines of relatively high molecular weight, so that the polyamine component has an average molecular weight of up to 2000. Suitable relatively high molecular weight polyamines of this type include the known polyether polyamines obtained by conversion of the hydroxyl groups of above-mentioned polyether polyols into primary amino groups.

The particle size (mean diameter) of the fully reacted water based anionic polyurethane-urea polymers are in a range of about 30 nanometer to about 500 nanometer, and preferably from about 40 nm to about 100 nm. The water-based dispersions of the inventive polyurethane-urea polymers have solids content in a range from about 20% by weight to about 45% by weight, and preferably from about 30% by weight to about 40% by weight.

The natural oil based poly-urethane dispersion disclosed above is efficient in terms of cost as well as the materials used.

The natural oil based poly-urethane dispersion disclosed above is substantially free of volatile organic chemicals, leachable tertiary amine catalysts and unreacted organic amine chain terminator compounds. The natural oil based poly-urethane dispersion disclosed above is also non-plastic and biodegradable. On account of its superior properties/characteristics, the natural oil based poly-urethane dispersion disclosed above is widely applicable in industry in a variety of ways, especially for direct food contact applications.

The natural oil based poly-urethane dispersion, disclosed above, has good adhesion characteristics on substrates including paper, polyethylene, polypropylene, polyester, nylon, ethylene vinyl acetate, cellophane, polyvinyl chloride, non-woven films and metalized films.

The natural oil based poly-urethane dispersion disclosed above can, therefore, be used as a laminating adhesive.

The natural oil based poly-urethane dispersion disclosed above can, therefore, also be used on conventional lamination machines for preparing flexible film or other packaging laminates.

Additionally, the natural oil based poly-urethane dispersion disclosed above can, therefore, also be used to produce a packaging material, which would possess properties of being waterproof, durable, long lasting, environment friendly, user friendly and capable of sealing heat.

Specifically, the natural oil based poly-urethane dispersion disclosed above can be used to produce a packaging material suitable for, amongst others, direct food contact and durable-goods applications.

Due to the fundamental nature of this invention, the natural oil based poly-urethane dispersion disclosed above can be used as packaging material for various goods, without any restriction/limitation of shape, size or nature of the goods.

All percentages, preferred amounts or measurements, ranges and endpoints thereof herein are inclusive. Numbers herein have no more precision than stated. All amounts, ratios, proportions and other measurements are by weight unless stated otherwise. All percentages refer to weight percent based on total composition according to the practice of the invention unless stated otherwise. Except in the examples, or where otherwise indicated, all numbers expressing quantities, percentages, OH numbers, functionalities and so forth in the specification are to be understood as being modified in all instances by the term “about.” Unless stated otherwise or recognized by those skilled in the art as otherwise impossible, steps of processes described herein are optionally carried out in sequences different from the sequence in which the steps are discussed herein. Furthermore, steps optionally occur separately, simultaneously or with overlap in timing. Unless stated otherwise, when an element, material, or step capable of causing undesirable effects is present in amounts or in a form such that it does not cause the effect to an unacceptable degree it is considered substantially absent for the practice of this invention. Those skilled in the art recognize that acceptable limits vary with equipment, conditions, applications, and other variables but can be determined without undue experimentation in each situation where they are applicable. In some instances, variation or deviation in one parameter may be acceptable to achieve another desirable end.

The foregoing description will so fully reveal the invention according to the conceptual point of view, so that others, by applying current knowledge will be able to modify and/or adapt, for various applications, such an invention without further research and without parting from the invention, and it is therefore to be understood that such adaptations and modifications will have to be considered as equivalent to this invention. The means and the materials to realise the different functions described herein could have a different nature without, for this reason, departing from the field of the invention. It is to be understood that the phraseology or terminology employed herein is for the purpose of description and not for limitation. It will also be apparent to those skilled in the art that other embodiments, improvements, details and uses can be made consistent with the letter and spirit of the foregoing disclosure and within the scope of this patent.

1. A natural oil based poly-urethane dispersion produced by:
a) forming a water dispersible NCO-terminated polyurethane prepolymer consisting essentially of the reaction product of:
i) a polyol component consisting of a mixture of ricinoleated natural ester based mono blocked polyol, which is prepared without using the system of alcoholysis for deriving the blocked natural ester oil; and a suitable carboxylic group-containing polyols, as disclosed herein; and
ii) a stoichiometric excess of an aromatic polyisocyanate component, as disclosed herein;
b) neutralizing the prepolymer with a suitable neutralizing agent as disclosed herein;
c) dispersing the prepolymer in solvent-free water in the manner disclosed herein; and
d) reacting the prepolymer with a suitable chain extender as disclosed herein;
wherein the said prepolymer, which is formed at a temperature less than about 100° C. in the manner disclosed herein, possesses superior characteristics that make it widely applicable in industry, as disclosed herein.

2. The natural oil based poly-urethane dispersion, as claimed in claim 1, wherein the said prepolymer is formed at temperatures in a range from about 40° C. to about 100° C.

3. The natural oil based poly-urethane dispersion, as claimed in claim 1, wherein ricinoleated natural ester based mono blocked polyol is prepared by way of a multi-step process, without using the system of alcoholysis for deriving the blocked natural ester oil.

4. The natural oil based poly-urethane dispersion, as claimed in claim 1, wherein the natural oils used to prepare ricinoleated natural ester based mono blocked polyol include:
a. canola oil, tall oil, soybean oil, safflower oil, linseed oil, castor oil, corn oil, sunflower oil, olive oil, canola oil, sesame oil, cottonseed oil, palm-based oils, rapeseed oil, tung oil, peanut oil, jatropha oil, and combinations thereof; and/or
b. plant-based oils, which may be natural or genetically modified vegetable oils, such as high oleic safflower oil, high oleic soybean oil, high oleic canola oil, high oleic peanut oil, high oleic sunflower oil, and high erucic rapeseed oil (crambe oil); and/or
c. animal fats such as fish oil, lard, and tallow; and/or
d. microbial oils, such as algal oil, including those that are genetically modified to increase yields and/or to obtain selective fatty acid distributions

5. The natural oil based poly-urethane dispersion, as claimed in claim 1, wherein the ricinoleated natural ester based mono blocked polyol constitutes up to about 95% by weight of the total weight of the polyol component.

6. The natural oil based poly-urethane dispersion, as claimed in claim 1, wherein the aromatic polyisocyante component used is an isomer of toluene diisocyanate and/or methylene diphenyl diisocyanate.

7. The natural oil based poly-urethane dispersion, as claimed in claim 1, wherein the ratio of the polyisocyanate component to the polyol component can be 1:4, and is most preferably 1:2.

8. The natural oil based poly-urethane dispersion, as claimed in claim 1, wherein the NCO-terminated prepolymer is dispersed in distilled/de-ionized water of temperature ranging from about 5° C. to about 90° C., with mild agitation.

9. The natural oil based poly-urethane dispersion, as claimed in claim 1, which is substantially free of volatile organic chemicals, leachable tertiary amine catalysts and unreacted organic amine chain terminator compounds.

10. The natural oil based poly-urethane dispersion, as claimed in claim 1, which is non-plastic.

11. The natural oil based poly-urethane dispersion, as claimed in claim 1, which is biodegradable.

12. The natural oil based poly-urethane dispersion, as claimed in claim 1, which is widely applicable in industry in a variety of ways, especially as packaging material for direct food contact applications and durable-goods applications without any restriction/limitation of shape, size or nature of the food/goods.

13. The natural oil based poly-urethane dispersion, as claimed in claim 1, which can be used as a laminating adhesive.

14. The natural oil based poly-urethane dispersion, as claimed in claim 1, which can be used on conventional lamination machines for preparing flexible film or other packaging laminates.

15. The natural oil based poly-urethane dispersion, as claimed in claim 1, which has good adhesion characteristics on substrates including paper, polyethylene, polypropylene, polyester, nylon, ethylene vinyl acetate, cellophane, polyvinyl chloride, non-woven films and metalized films.
